(19) United States
(12) Patent Application Publication
(10) Pub. No.: US 2008/0055911 A1
(43) Pub. Date: Mar. 6, 2008

(54) LIGHT SOURCE DEVICE FOR A PROJECTOR

(76) Inventor: Yu-Nung Shen, Taipei (TW)

Correspondence Address: BAKER & DANIELS LLP;111 E. WAYNE STREET, SUITE 800, FORT WAYNE, IN, 46802, US

(21) Appl. No.: 11/842,422

(22) Filed: Aug. 21, 2007

(30) Foreign Application Priority Data
Aug. 30, 2006 (TW) 095215555

(51) Int. Cl. F21V 29/02

(52) U.S. Cl. 362/294; 362/373

(57) ABSTRACT

A light source device for a projector includes a light source unit and a heat dissipation unit. The light source unit includes a circuit board, and a plurality of light emitting diodes mounted on and in front of the circuit board and arranged in an array. The heat dissipation unit includes a metal mounting seat permitting the circuit board to be mounted thereon for thermal contact therewith, and a heat-dissipating module connected to the metal mounting seat for dissipating heat from the metal mounting seat.

### CROSS-REFERENCE TO RELATED APPLICATION

This application claims priority of Taiwanese Application No. 095215555, filed on Aug. 30, 2006.

### BACKGROUND OF THE INVENTION

1. Field of the Invention

This invention relates to a light source device, and more particularly to a light source device for a projector.

2. Description of the Related Art

A light source of an optical projector is typically a halogen bulb or a high-pressure mercury bulb. Such a light source has a drawback in that when dust deposits on the light source or fingerprints are formed on the same, the light source may break due to the generation of high temperatures and uneven heating thereof. Furthermore, halogen bulbs and high-pressure mercury bulbs are expensive.

### SUMMARY OF THE INVENTION

The object of this invention is to provide a light source device for a projector which is durable and cost-effective.

According to this invention, a light source device for a projector includes a light source unit and a heat dissipation unit. The light source unit includes a circuit board, and a plurality of light emitting diodes mounted on and in front of the circuit board and arranged in an array. The heat dissipation unit includes a metal mounting seat permitting the circuit board to be mounted thereon for thermal contact therewith, and a heat-dissipating module connected to the metal mounting seat for dissipating heat from the metal mounting seat.

Since heat can be dissipated from the light source unit, the service life of the light source device is increased. Furthermore, through use of the circuit board and the light emitting diodes for light generation, the light source unit is cost-effective.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a partly exploded perspective view of the first preferred embodiment of a light source device for a projector according to this invention;

FIG. 2 is a schematic side view of the first preferred embodiment;

FIG. 3 is a schematic side view of the second preferred embodiment of a light source device for a projector according to this invention; and

FIG. 4 is a schematic side view of the third preferred embodiment of a light source device for a projector according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

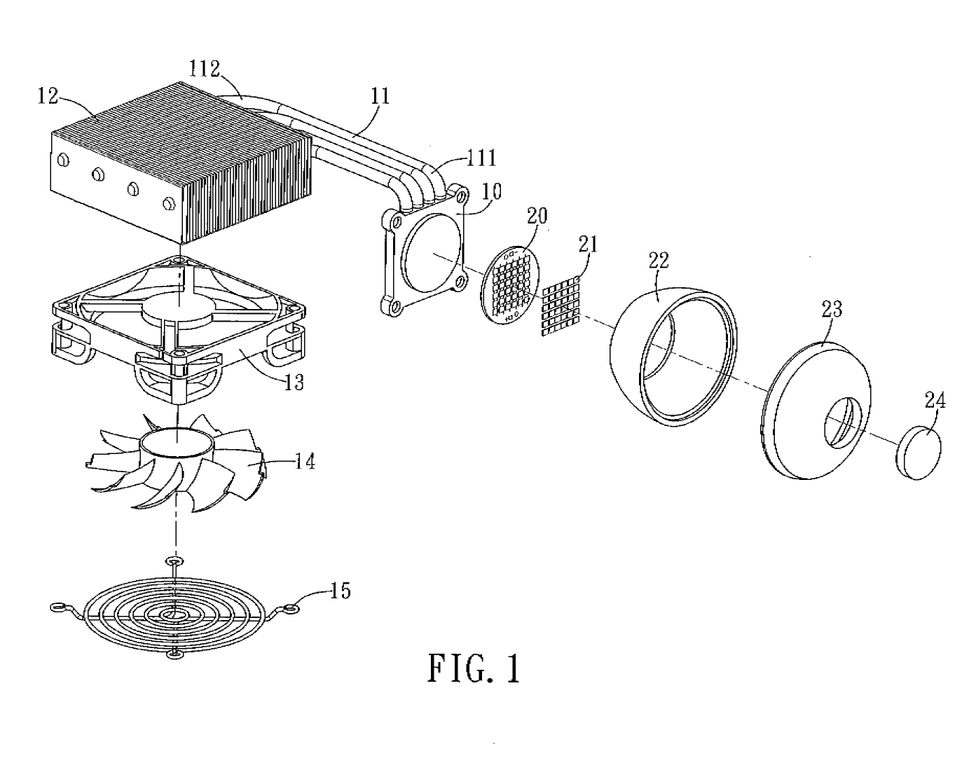

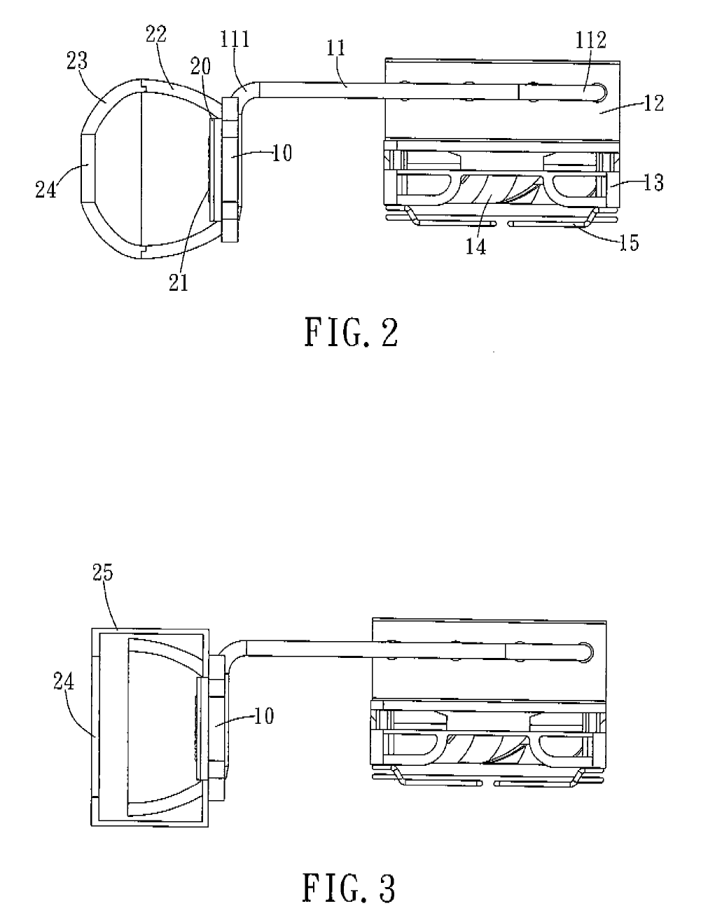

With reference to FIGS. 1 and 2, the first preferred embodiment of a light source device for a projector according to this invention includes a light source unit and a heat dissipation unit.

The light source unit includes a circuit board 20, a plurality of light emitting diodes 21, a reflection shield 22, a transparent cover 23, and a condensing lens 24. The light emitting diodes 21 are mounted on and in front of the circuit board 20, and are arranged in an array. The reflection shield 22 surrounds the circuit board 20. The transparent cover 23 is disposed on and in front of the reflector shield 22. The condensing lens 24 is mounted on the transparent cover 23.

The heat dissipation unit includes a metal mounting seat 10 and a heat-dissipating module. The circuit board 20 is mounted on and in thermal contact with the metal mounting seat 10. The heat-dissipating module is connected to the metal mounting seat 10 for dissipating heat from the metal mounting seat 10. The heat-dissipating module includes a heat-conducting tube 11, a dissipating-fin module 12, a fan-mounting seat 13, a fan 14, and a protective frame 15. The heat-conducting tube 11 has a first end 111 connected to and in thermal contact with the metal mounting seat 10, and a second end 112 opposite to the first end 111 and connected to and in thermal contact with the dissipating-fin module 12. The fan-mounting seat 13 is mounted on the dissipating-fin module 12. The fan 14 is disposed rotatably on the fan-mounting seat 13. The protective frame 15 is mounted on the fan-mounting seat 13 to confine the fan 14 between the fan-mounting seat 13 and the protective frame 15.

In this embodiment, the circuit board 20 is made of aluminum, and is connected electrically to the light emitting diodes 21. Due to the presence of the heat dissipation unit, overheating of the light source unit can be prevented. Hence, the lighting effect and the service life of the light source unit are increased.

FIG. 3 shows the second preferred embodiment of a light source device for a projector according to this invention, which is similar in construction to the first preferred embodiment except that the transparent cover 23 (see FIG. 2) is omitted, and the condensing lens 24 is mounted on a support frame 25 extending integrally from the metal mounting seat 10.

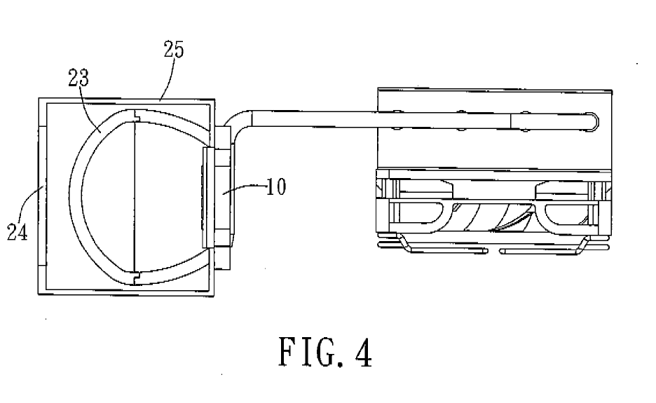

FIG. 4 shows the third preferred embodiment of a light source device for a projector according to this invention, which is similar in construction to the first preferred embodiment except that the condensing lens 24 is mounted on a support frame 25 extending integrally from the metal mounting seat 10, rather than being mounted on the transparent cover 23.

With this invention thus explained, it is apparent that numerous modifications and variations can be made without departing from the scope and spirit of this invention. It is therefore intended that this invention be limited only as indicated by the appended claims.

I claim:

1. A light source device for a projector, said light source device comprising:
a light source unit including a circuit board, and a plurality of light emitting diodes mounted on and in front of said circuit board and arranged in an array; and
a heat dissipation unit including a metal mounting seat permitting said circuit board to be mounted thereon for thermal contact therewith, and a heat-dissipating module connected to said metal mounting seat for dissipating heat from said metal mounting seat.

2. The light source device as claimed in claim 1, wherein said light source unit further includes:
a reflection shield surrounding said circuit board;
a transparent cover disposed on and in front of said reflection shield; and
a condensing lens mounted on said transparent cover.

3. The light source device as claimed in claim 1, wherein said heat dissipation module includes:
a heat-conducting tube having a first end connected to and in thermal contact with said metal mounting seat, and a second end opposite to said first end;
a dissipating-fin module connected to and in thermal contact with said second end of said heat-conducting tube;
a fan-mounting seat mounted on said dissipating-fin module;
a fan disposed rotatably on said fan-mounting seat; and
a protective frame mounted on said fan-mounting seat to confine said fan between said fan-mounting seat and said protective frame.
